(19) United States
(12) Patent Application Publication
(10) Pub. No.: US 2005/0087002 A1
(43) Pub. Date: Apr. 28, 2005

(54) Viscosity-change-detecting apparatus and stirring rotor

(76) Inventors: Yoshio Kanzaki, Nara-ken (JP); Iko Ito, Osaka (JP); Munehiro Kanzaki, Hyogo-ken (JP)

Correspondence Address: SUGHRUE MION, PLLC, 2100 PENNSYLVANIA AVENUE, N.W., SUITE 800, WASHINGTON, DC, 20037, US

(21) Appl. No.: 10/503,768

(22) PCT Filed: Feb. 7, 2003
(86) PCT No.: PCT/JP03/01310

(30) Foreign Application Priority Data
Feb. 8, 2002 (JP) 200232962
Oct. 15, 2002 (JP) 2002300824

(51) Int. Cl. G01N 11/14

(52) U.S. Cl. 73/54.28

(57) ABSTRACT

A viscosity-change-detecting apparatus 5 comprising (a) an elastically deflectable and/or twistable member 16, and (b) a movable permanent magnet member 13 mounted directly or via a connecting member to the elastic member 16 such that the movable permanent magnet member 13 moves depending on the deformation of the elastic member 16, part of the elastic member 16 being fixed to a support 135 for the viscosity-change-detecting apparatus 5, so that the elastic member 16 is subjected to elastic deflection and/or torsion with rotation and/or vibration in the rotating liquid, whereby the relative position of the movable permanent magnet member 13 to a fixed external detector 6 changes depending on the viscosity change of the liquid, and whereby the change of the relative position is detected by the external detector 6 to detect the viscosity change of the liquid. This viscosity-change-detecting apparatus is suitable for providing the function of detecting viscosity change to stirring rotors, stirring apparatuses, reaction apparatuses and semi-automatic synthesis apparatuses.

### FIELD OF THE INVENTION

The present invention relates to a viscosity-change-detecting apparatus disposed in a rotating liquid, which is suitable for detecting the viscosity change of the liquid, and a stirring rotor capable of stirring the reaction liquid by rotating a support mechanism comprising a permanent magnet member subjected to a strong rotating magnetic field, which is suitable for detecting the change of the state of the reaction liquid.

### BACKGROUND OF THE INVENTION

In the synthesis of organic polymers, color conditioning in the production of paints, the preparation of adhesives, etc., high-viscosity solutions are sometimes stirred and mixed. Because acids, organic solvents, etc. are contained in stirred solutions, stirring apparatuses are required to have chemical resistance such as acid resistance and alkali resistance, etc. and wear resistance. Stirring and mixing are conducted in containers with reduced or increased pressure in many times.

Though core rotors in a shape of a rod with or without a thick or thin center portion for use in conventional magnetic stirrers, which are sealed in fluororesins, are suitable for the stirring of low-viscosity solutions, they provide only a weak stirring force to high-viscosity solutions, failing to uniformly stir the entire reaction liquid in the container. On the other hand, in a stirring apparatus comprising a shaft having at an end a stirring blade inserted into a container and rotated for stirring, which has conventionally been used for stirring high-viscosity solutions, etc., its hole, through which the shaft penetrates, should be sealed, when it is used in a container with a reduced or increased pressure. Accordingly, the apparatus inevitably has a complicated structure, and repair and maintenance should be conducted for the exchange of sealing members, etc.

The inventors thus proposed, as a reaction apparatus for high-viscosity solutions, an experimental reaction apparatus comprising a housing, into which a reaction container is inserted from above, a temperature control means comprising a means for heating and/or cooling the reaction container, means for generating a rotating magnetic field, which is disposed under the reaction container, and a rotor rotated by the action of the means for generating a rotating magnetic field, which is disposed in the reaction container, the rotor comprising a yoke member, and a ball bearing mounted to a lower center surface of the yoke member, the ball bearing comprising a cylindrical member rotatably holding pluralities of balls and having pluralities of through-hole, such that lower end portions of pluralities of balls are exposed from a lower end of the cylindrical member (see JP 11-128731 A). They also proposed a stirring apparatus comprising a housing, into which a container with an upper opening is inserted from above and fixed thereto, a means for generating a rotating magnetic field, which is disposed under the fixed container, a reaction container disposed in the fixed container, a rotor rotated by the action of the means for generating a rotating magnetic field, which is fixed to a lower end of the fixed container, and a stirring member inserted into the reaction container from above, the rotor comprising a yoke member, and a bearing mounted to a lower center surface of the yoke member (see JP 11-244680 A).

In any of the above apparatuses, the rotor comprises a yoke support, to whose lower surface a bearing is mounted, such that the rotor is easily rotated by the action of a rotating magnetic field generated from the means for generating a rotating magnetic field. Accordingly, sufficient stirring can be conducted even on high-viscosity solutions.

However, because the ball bearing and other bearings used in the rotor are usually made of stainless steel or ceramics in JP 11-128731 A and JP 11-244680 A, it has been found that corrosion is serious in reactions under acidic conditions. Though other parts than the ball bearing and other bearings, such as the yoke member of the stirring rotor, etc., can be protected by coatings of acid-resistant resins, etc., the ball bearing and other bearings cannot be coated.

The inventors thus proposed a stirring apparatus comprising a container having a fixed shaft perpendicular to its bottom, and a stirring rotor having a tubular member rotatably receiving the fixed shaft at bottom, the stirring rotor being rotatable by a rotating magnet mounted to a reaction apparatus, and a reaction apparatus and a semi-automatic synthesis apparatus comprising such a stirring apparatus (Japanese patent application No. 2001-067690). With the stirring rotor having such structure, a chemically resistant coating can be formed on the entire stirring rotor.

However, because the reaction apparatus and semi-automatic synthesis apparatus comprising the stirring apparatus described in Japanese Patent Application No. 2001-067690 determines the viscosity of the reaction liquid from a torque applied to the means for generating a rotating magnetic field, they are insufficient in the sensitivity to viscosity change during the reaction and the accuracy of viscosity measurement.

Because a long stirring member extends upward in the stirring rotor described in Japanese patent application No. 2001-067690, large space is occupied by the stirring member when this stirring rotor is placed in the container, making it difficult to dispose electrodes, etc. in the container, and thus making it difficult to measure the concentration of hydrogen ions, a water content, etc. in the reaction liquid.

### OBJECTS OF THE INVENTION

Accordingly, an object of the present invention is to provide a viscosity-change-detecting apparatus capable of detecting the viscosity change of a reaction liquid easily and accurately.

Another object of the present invention is to provide a stirring rotor occupying small space in a container, making it easy to arrange electrodes, etc. in a stirring apparatus.

### DISCLOSURE OF THE INVENTION

As a result of intensive research in view of the above objects, the inventors have found that because in a viscosity-change-detecting apparatus comprising (a) an elastically deflectable and/or twistable member, and (b) a movable permanent magnet member attached directly or via a connecting member to the elastic member such that it moves depending on the deformation of the elastic member, with part of the elastic member fixed to a support mechanism of the viscosity-change-detecting apparatus, the relative position of the movable permanent magnet member to an external detector disposed at a fixed position changes depending on the viscosity change of a rotating liquid, the detection of a relative position change by the external detector makes it possible to measure the viscosity change of the rotating liquid easily and accurately. The inventors have also found that when in a stirring rotor rotating by the action of a rotating magnetic field generated by a rotating magnetic field apparatus, a horizontal member extending from the rotation center and being rotatable for generating a stirring function is fixed to a fixed shaft by a fixed vertical member extending along a rotation center axis and non-rotatably attached to the fixed shaft for supporting the rotor, space occupied by the stirring rotor is drastically reduced in the container, whereby electrodes, etc. are easily disposed in a stirring apparatus. The inventors have further found that when in the stirring rotor rotating by the action of a rotating magnetic field generated from the rotating magnetic field apparatus, a support mechanism having a cylindrical portion for rotatably receiving a stirring-rotor-supporting fixed shaft at bottom and horizontally extending from the rotation center is used as a stirring member, space occupied by the stirring-rotor is drastically reduced in a container, thereby making it easy to dispose electrodes, etc. in a stirring apparatus. The present invention has been completed based on these discoveries.

Thus, the viscosity-change-detecting apparatus of the present invention comprises (a) an elastically deflectable and/or twistable member, and (b) a movable permanent magnet member mounted directly or via a connecting member to the elastic member such that it moves depending on the deformation of the elastic member, part of the elastic member being fixed to a support mechanism of the viscosity-change-detecting apparatus, so that the elastic member is subjected to elastic deflection and/or torsion with rotation and/or vibration in the rotating liquid, whereby the relative position of the movable permanent magnet member to a fixed external detector changes depending on the viscosity change of the liquid, and the change of the relative position is detected by the external detector to detect the viscosity change of the liquid.

The elastic member is preferably at least one selected from the group consisting of a flat spring, a coil spring and a fluororubber plate. The external detector is preferably an induction coil for detecting current or voltage induced by the rotation or vibration of the movable permanent magnet member.

The first stirring rotor of the present invention comprises (a) a fixed vertical member extending along a rotation center axis and non-rotatably attached to a fixed shaft for supporting the rotor, and (b) a horizontal member rotatably engaging the fixed vertical member such that it horizontally extends from a rotation center, thereby having the function of stirring by rotation.

In the first stirring rotor, the fixed vertical member is in a tubular structure having a hole with an opening at a lower end, into which the fixed shaft is inserted, having a means for engaging or being fastened to the fixed shaft. One example of a means for fastening the fixed vertical member to the fixed shaft is a female screw portion formed in the hole of the fixed vertical member, which is fastened to a male screw portion formed in a tip end portion of the fixed shaft. Another example of a means for fastening the fixed vertical member to the fixed shaft is a combination of (a) a female screw portion formed in the hole of the fixed vertical member, and (b) a joint screw in a hollow pipe comprising a male screw portion threadable to the female screw portion of the fixed vertical member, and a female screw portion threadable to a male screw portion formed in a tip end portion of the fixed shaft. One example of a means for causing the fixed vertical member to engage the fixed shaft is a hole of the fixed vertical member, whose upper portion is worked to engage the tip end portion of the fixed shaft, which is in a slantingly cut shape, a rectangular prism shape, a semi-columnar shape, or an elliptic columnar shape. Another example of a means for causing the fixed vertical member to engage the fixed shaft is an engaging screw formed in the fixed vertical member and having such a shape that it engages the tip end portion of the fixed shaft, the tip end portion of the fixed shaft being in a slantingly cut shape, a rectangular prism shape, a semi-columnar shape, or an elliptic columnar shape. A column is preferably screwed to a portion of the fixed vertical member projecting above the horizontal member, such that it vertically extends upward from the horizontal member.

The second stirring rotor of the present invention comprises (a) a horizontal member extending from a rotation center for exhibiting a stirring function, and (b) a tubular member having at a lower end an opening for receiving the fixed shaft for supporting the rotor, and mounted to the horizontal member substantially at a rotation center from below.

In the second stirring rotor, the tubular member preferably extends upward the horizontal member and has a stopper abutting the fixed shaft. The stirring rotor preferably has a column vertically extending upward the horizontal member along a rotation center axis, which is threaded to an upper projection of the tubular member. The tubular member preferably comprises a tubular body receiving the fixed shaft, and a nut portion provided in a lower end portion of the tubular body and having a tapered opening, the stopper being a stopper screw (I) threaded to the tubular body. A stopper screw (II) is preferably further provided to fasten the stopper screw (I) to the fixed vertical member.

In the first and second stirring rotors, though the horizontal member may be a soft magnetic yoke, a rotating permanent magnet member is preferably fixed to a lower surface of at least one end. The horizontal member may also be made of a non-magnetic material, with a rotating permanent magnet member fixed to a lower surface of at least one end. At least the horizontal member is preferably coated with chemically resistant resins, ceramics, porcelain enamels or glass. When the first and second stirring rotors have the rotating permanent magnet member, the rotating permanent magnet member is preferably coated with chemically resistant resins, ceramics, porcelain enamels or glass. The horizontal member preferably has curved side surfaces at least near the rotation center.

The first viscosity-change-detecting stirring rotor of the present invention comprises the apparatus of the present invention for detecting the viscosity change of the liquid while stirring the liquid, with a support mechanism comprising (a) a fixed vertical member extending along a rotation center axis and non-rotatably attached to the fixed shaft for supporting the rotor or the fixed rod, and (b) a horizontal member extending from a rotation center and rotatably engaging the fixed vertical member, so that it has the function of stirring by rotation by the action of a rotating magnetic field, part of the elastic member in the viscosity-change-detecting apparatus being fixed to the fixed vertical member or the horizontal member in the support mechanism.

In the first viscosity-change-detecting stirring rotor, the fixed vertical member preferably has a tubular structure having a hole with an opening at a lower end for receiving the fixed shaft, and has a means for engaging or being fastened to the fixed shaft. One example of a means for fastening the fixed vertical member to the fixed shaft is a female screw portion formed in the hole of the fixed vertical member such that it is fastened to a male screw portion formed in a tip end portion of the fixed shaft. Another example of a means for fastening the fixed vertical member to the fixed shaft is a combination of (a) a female screw portion formed in the hole of the fixed vertical member, and (b) a joint screw in a hollow pipe shape comprising a male screw portion threadable to the female screw portion of the fixed vertical member, and a female screw portion threadable to a male screw portion formed in a tip end portion of the fixed shaft. One example of a means for causing the fixed vertical member to engage the fixed shaft is a hole of the fixed vertical member, whose upper portion is worked to have such a shape engageable with the tip end portion of the fixed shaft, which is in a slantingly cut shape, a rectangular prism shape, a semi-columnar shape, or an elliptic columnar shape. Another example of a means for causing the fixed vertical member to engage the fixed shaft is an engaging screw formed on the fixed vertical member and worked to have such a shape engageable with the tip end portion of the fixed shaft, which is in a slantingly cut shape, a rectangular prism shape, a semi-columnar shape, or an elliptic columnar shape.

In a preferred example of the first viscosity-change-detecting stirring rotor, (a) the support mechanism further comprises a column threaded to a portion of the fixed vertical member projecting above the horizontal member such that it vertically extends upward the horizontal member, (b) one end of the elastic member in the viscosity-change-detecting apparatus is detachably mounted to the column and radially extends therefrom, and (c) the movable permanent magnet member is detachably mounted to the other end of the elastic member, whereby the distance from the fixed external detector to the movable permanent magnet member changes depending on the viscosity change of the liquid, the change of the distance being detected by the external detector to know the viscosity change of the liquid. The elastic member is preferably a flat spring. The elastic member is preferably provided with a blade member for increasing the sensitivity of detecting the viscosity change.

The second viscosity-change-detecting stirring rotor of the present invention comprises the viscosity-change-detecting apparatus of the present invention, and is rotated by the action of a rotation-force-providing means to detect the viscosity change of the liquid while stirring the liquid, (a) the stirring rotor comprising a support mechanism comprising a horizontal member extending from a rotation center and having a stirring function, and a column vertically extending from the horizontal member along a rotation center axis, the support mechanism being rotatable by the action of the rotation-force-providing means, and (b) in the viscosity-change-detecting apparatus, part of the elastic member being detachably attached to the horizontal member or the column in the support mechanism such that it rotates with the support mechanism, whereby the elastic member is elastically deflected and/or twisted by rotation in the liquid, a rotation radius of the movable permanent magnet member changes depending on the viscosity change of the liquid, and thus the viscosity change of the liquid can be known by detecting the change of the rotation radius by the fixed external detecting means.

In a preferred example (Example 2-1) of the second viscosity-change-detecting stirring rotor, the elastic member is a flat spring, one end of which is detachably mounted to the column, and the flat spring comprises a first deflectable portion radially extending from the column, a first bent portion connected to an outer end of the first deflectable portion such that it is bent toward an opposite side to the viscosity-resistance-receiving surface of the first deflectable portion, a second deflectable portion connected to the first deflectable portion via the first bent portion substantially in a doglegged shape, and a second bent portion connected to a tip end of the second deflectable portion such that it is bent toward the periphery side, the movable permanent magnet member being mounted to the other end of the flat spring such that it extends toward the periphery from the second bent portion, whereby the movable permanent magnet member rotating in the liquid becomes closer to the rotation center axis from the periphery side as the viscosity resistance of the liquid increases, resulting in a reduced rotation radius.

In another preferred example (Example 2-2) of the second viscosity-change-detecting stirring rotor, (a) one end of the elastic member is detachably attached to the column and radially extends therefrom, and (b) the movable permanent magnet member is detachably mounted to the other end of the elastic member, whereby the movable permanent magnet member rotating in the liquid becomes closer to the rotation center axis from the periphery side as the viscosity resistance of the liquid increases, resulting in a reduced rotation radius. The elastic member is preferably a flat spring or a fluororubber plate in a frame shape.

In any of the first and second viscosity-change-detecting stirring rotors, the means for detecting the change of the rotation radius preferably comprises an induction coil for detecting current or voltage induced by the rotation of the movable permanent magnet member, and a means for outputting the detected current or voltage. The horizontal member is preferably a soft magnetic yoke. The permanent magnet member for rotating the horizontal member by the action of a rotating magnetic field is preferably mounted to a lower surface of at least one end of the horizontal member. The rotating permanent magnet member is preferably coated with chemically resistant resins, ceramics, porcelain enamels or glass.

The third viscosity-change-detecting stirring rotor of the present invention comprises the viscosity-change-detecting apparatus of the present invention, and rotates by the action of a rotation-force-providing means for detecting the viscosity change of the liquid while stirring the liquid, further comprising (a) a support mechanism comprising a horizontal member extending from a rotation center for a stirring function, and a column vertically extending from the horizontal member along a rotation center axis, such that it is rotated by the action of the rotation-force-providing means, and (b) a reference permanent magnet fixed to the horizontal member or the column in the support mechanism; (c) with part of the elastic member detachably attached to the horizontal member or the column in the support mechanism, the viscosity-change-detecting apparatus rotating together with the support mechanism; (d) the movable permanent magnet member being mounted such that its relative position to the reference permanent magnet changes depending on the deformation of the elastic member; whereby the elastic member is elastically deflected and/or twisted in the liquid to cause the relative position of the movable permanent magnet member to the reference permanent magnet to change depending on the viscosity change of the liquid, so that the change of the relative position can be detected by a detector disposed at a fixed position to know the viscosity change of the liquid.

In the third viscosity-change-detecting stirring rotor, the means for detecting the change of the relative position preferably comprises an induction coil (I) for detecting current or voltage induced by the rotation of the movable permanent magnet member, an induction coil (II) for detecting current or voltage induced by the rotation of the reference permanent magnet, and a means for outputting the phase A of the induced current or voltage detected by the induction coil (I) and the phase B of the induced current or voltage detected by the induction coil (II). The reference permanent magnet is attached to a lower surface of at least one end of the horizontal member, and acts as a rotating permanent magnet member subjected to the action of the rotating magnetic field to rotate the rotor. The reference permanent magnet is preferably coated with chemically resistant resins, ceramics, porcelain enamels or glass. The horizontal member is preferably made of a non-magnetic material. Another reference permanent magnet may be mounted to an upper portion of the horizontal member at a different height from that of the movable permanent magnet member, so that the relative position of the movable permanent magnet member to another reference permanent magnet changes.

In a preferred example of the third viscosity-change-detecting stirring rotor, it is preferable that (a) one end of the elastic member is detachably attached to the column and radially extends therefrom, and that (b) the movable permanent magnet member is detachably mounted to the other end of the elastic member. The elastic member is preferably a flat spring or a fluororubber plate in a frame shape.

In any of the first to third viscosity-change-detecting stirring rotors, the horizontal member preferably has curved side surfaces at least near the rotation center. A means for limiting the movement of the movable permanent magnet member may be provided. At least the movable permanent magnet member and the horizontal member are preferably coated with chemically resistant resins, ceramics, porcelain enamels or glass.

In the second and third viscosity-change-detecting stirring rotors, the rotation-force-providing means is a rotating magnetic field, and a tubular member having at a lower end an opening for receiving a fixed shaft for supporting the rotor and further having a stopper abutting the fixed shaft is mounted to the horizontal member substantially at a rotation center from below such that it projects upward. The column is preferably threaded to an upper projecting portion of the tubular member such that it extends above the horizontal member. The tubular member preferably comprises a tubular body receiving the fixed shaft, and a nut portion connected to the lower end portion of the tubular body with a tapered opening, and the stopper is preferably a stopper screw (I) threaded to the tubular body. A stopper screw (II) for further fastening the stopper screw (I) is preferably provided.

Any of the second and third viscosity-change-detecting stirring rotors may comprise a motor as the rotation-force-providing means, the column being connected to the motor via a connecting means for rotation.

The first stirring apparatus of the present invention comprises the viscosity-change-detecting apparatus of the present invention for detecting the viscosity change of the liquid while stirring the liquid, further comprising (a) a container receiving the viscosity-change-detecting apparatus, and (b) a means for stirring the liquid, (c) part of the elastic member in the viscosity-change-detecting apparatus being detachably mounted to the container via a fixed support, whereby the distance from the fixed external detector to the movable permanent magnet member changes depending on the viscosity change of the liquid, so that the change of the distance can be detected by the external detector to know the viscosity change of the liquid.

In the first stirring apparatus, it is preferable that (a) the container comprises a fixed shaft vertically projecting from a bottom center, that (b) the stirring means is a stirring rotor comprising a horizontal member extending from a rotation center such that it has a stirring function, and a tubular member having at a lower end an opening for receiving the fixed shaft and mounted to the horizontal member substantially at a rotation center from below, that (c) the fixed support is non-rotatably attached to the fixed shaft above the stirring rotor and vertically extends upward in a columnar shape, such that the stirring rotor is rotatable, that (d) the radially extending elastic member in the viscosity-change-detecting apparatus has one end detachably attached to the fixed support, and that (e) the movable permanent magnet member is detachably mounted to the other end of the elastic member.

In the first stirring apparatus, the fixed support preferably has a hole for receiving the fixed shaft at a lower end, the fixed shaft being provided with an engaging means or a fastening means. One example of a means for fastening the fixed support to the fixed shaft is a female screw portion fastened to a male screw portion formed in a tip end portion of the fixed shaft, which is formed in the hole of the fixed support. Another example of a means for fastening the fixed support to the fixed shaft is a combination of (a) a female screw portion formed in the hole of the fixed support, and (b) a joint screw in a hollow pipe shape comprising a male screw portion threadable to the female screw portion of the fixed support, and a female screw portion threadable to the male screw portion formed in a tip end portion of the fixed shaft. One example of a means for causing the fixed support to engage the fixed shaft is a hole of the fixed member, whose upper portion is worked to engage the tip end portion of the fixed shaft, which is in a slantingly cut shape, a rectangular prism shape, a semi-columnar shape, or an elliptic columnar shape. Another example of a means for causing the fixed vertical member to engage the fixed shaft is an engaging screw formed in the fixed member and having such a shape that it engages the tip end portion of the fixed shaft, the tip end portion of the fixed shaft being in a slantingly cut shape, a rectangular prism shape, a semi-columnar shape, or an elliptic columnar shape.

In the first stirring apparatus, the elastic member is preferably a flat spring. A blade member for increasing detection sensitivity is preferably mounted to the elastic member. A rotating permanent magnet member is preferably fixed to a lower surface of at least one end of the horizontal member of the stirring rotor. Though the horizontal member of the stirring rotor may be a soft magnetic yoke, a rotating permanent magnet member is preferably mounted to a lower surface of at least one end. Alternatively, the horizontal member of the stirring rotor member may be made of a non-magnetic material, and a rotating permanent magnet member may be fixed to a lower surface of at least one end of the horizontal member. At least the horizontal member of the stirring rotor is preferably coated with chemically resistant resins, ceramics, porcelain enamels or glass. When the horizontal member of the stirring rotor comprises the rotating permanent magnet member, the rotating permanent magnet member is preferably coated with chemically resistant resins, ceramics, porcelain enamels or glass. The horizontal member of the stirring rotor member preferably has curved side surfaces at least near the rotation center.

The second stirring apparatus of the present invention comprises (a) a container comprising a fixed shaft vertically projecting from a bottom center, and (b) a fixed vertical member in the above the first viscosity-change-detecting stirring rotor, which has a tubular structure having a hole for receiving the fixed shaft at a lower end and is provided with a means engaging or fastened to the fixed shaft, the tip end portion of the fixed shaft being worked to have such a shape engageable with or threadable to the engaging or threading means of the fixed vertical member.

The third stirring apparatus of the present invention comprises (a) a container having a fixed shaft vertically projecting from a bottom center, and (b) the above second viscosity-change-detecting stirring rotor comprising a tubular member mounted upward from below, which has at a lower end an opening for receiving the fixed shaft substantially at a rotation center of the horizontal member and is provided with a stopper abutting the fixed shaft, an upper end of the fixed shaft inserted into the tubular member abutting the stopper.

### BRIEF DESCRIPTION OF THE DRAWINGS

FIG. 1 is a vertical cross-sectional view showing a stirring apparatus according to one embodiment of the present invention;

FIG. 2 is a plan view showing the movement of the movable permanent magnet member in the viscosity-change-detecting apparatus in the stirring apparatus shown in FIG. 1;

FIG. 3 is a partial enlarged cross-sectional view showing the structure of each member mounted to a fixed shaft of the stirring apparatus shown in FIG. 1;

FIG. 4(a) is a plan view showing one example of the arrangement of the rotatable permanent magnets;

FIG. 4(b) is a cross-sectional view taken along the line G-G in FIG. 4(a);

FIG. 5 is an exploded perspective view showing a viscosity-change-detecting stirring rotor according to one embodiment of the present invention;

FIG. 6 is a partial cross-sectional view showing the relation between the fixed shaft and the fixed vertical member in the stirring rotor shown in FIG. 5 for detecting viscosity change;

FIG. 7 is a plan view showing the movement of the movable permanent magnet member of the viscosity-change-detecting stirring rotor according to another embodiment of the present invention;

FIG. 8 is a partial enlarged, exploded view showing the structure of each member such as a tubular member in the viscosity-change-detecting stirring rotor according to a further embodiment of the present invention;

FIG. 9 is a partial enlarged cross-sectional view showing the structure of each member attached to the fixed shaft of the viscosity-change-detecting stirring rotor shown in FIG. 8;

FIG. 10 is a perspective view showing the viscosity-change-detecting stirring rotor according to a further embodiment of the present invention;

FIG. 11 is a front view showing the viscosity-change-detecting stirring rotor in FIG. 10;

FIG. 12 is a plan view showing the movement of the movable permanent magnet member of the viscosity-change-detecting stirring rotor shown in FIG. 10;

FIG. 13 is a perspective view showing a stirring rotor with a motor for detecting viscosity change according to one embodiment of the present invention;

FIG. 14 is a plan view showing the movement of the movable permanent magnet member in the stirring rotor of FIG. 13 for detecting viscosity change;

FIG. 15 is a vertical cross-sectional view showing a stirring apparatus according to another embodiment of the present invention;

FIG. 16 is a vertical cross-sectional view showing one example of a hydrogen-ion-detecting electrode formed in the stirring apparatus shown in FIG. 15;

FIG. 17 is a perspective view showing a stirring rotor according to another embodiment of the present invention;

FIG. 18 is a perspective view showing a stirring rotor according to a further embodiment of the present invention;

FIG. 19 is a perspective view showing a stirring rotor according to a still further embodiment of the present invention; and

FIG. 20 is a perspective view showing a stirring rotor according to a still further embodiment of the present invention.

### THE BEST MODE FOR CARRYING OUT THE INVENTION

Referring to the attached drawings, viscosity-change-detecting apparatuses according to embodiments of the present invention, viscosity-change-detecting stirring rotors comprising them, stirring rotors, and stirring apparatuses comprising them are explained below.

[1] Viscosity-Change-Detecting Apparatus, Viscosity-Change-Detecting Stirring Rotor and Stirring Apparatus Comprising it

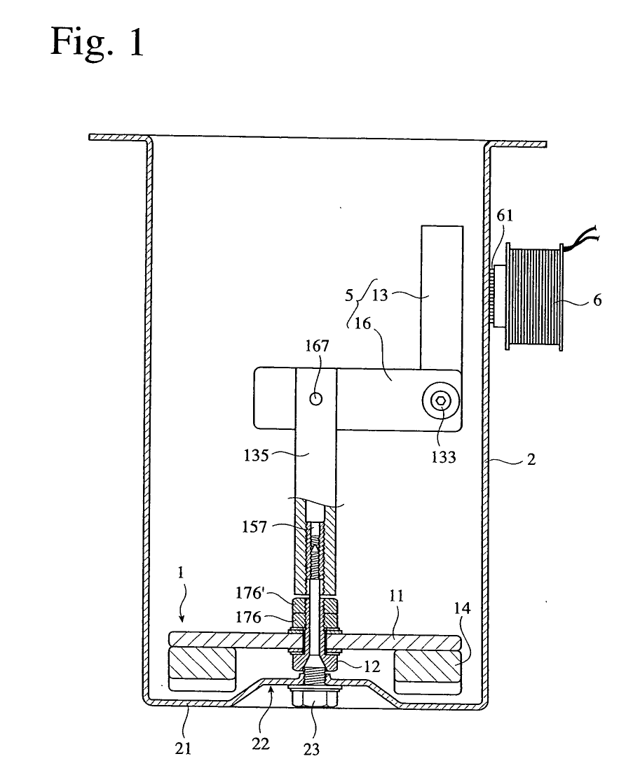

FIG. 1 shows one example of a stirring apparatus comprising the viscosity-change-detecting apparatus 5 of the present invention in a container 2. The cylindrical container 2 with an upper opening receives a stirring rotor 1 and the viscosity-change-detecting apparatus 5 with a slight horizontal gap. A shaft 23 is fixed at the center of the container bottom. This stirring apparatus, as shown in FIG. 1, comprises: (a) the stirring rotor 1 having a horizontal stirring member 11 extending from the rotation center, a tubular member 12 having a lower opening for receiving the fixed shaft 23 and attached to the horizontal member 11 substantially at a rotation center from below, and permanent magnets 14, 14 for rotating the horizontal member 11 by the action of a rotating magnetic field; (b) a fixed support 135 non-rotatably fastened to the fixed shaft 23 above the stirring rotor 1; and (c) the viscosity-change-detecting apparatus 5 having radially extending flat springs 16, 16 detachably attached to the fixed support 135 substantially at one end, and a movable permanent magnet member 13 detachably attached to the other ends of the flat springs 16, 16 with a screw 133.

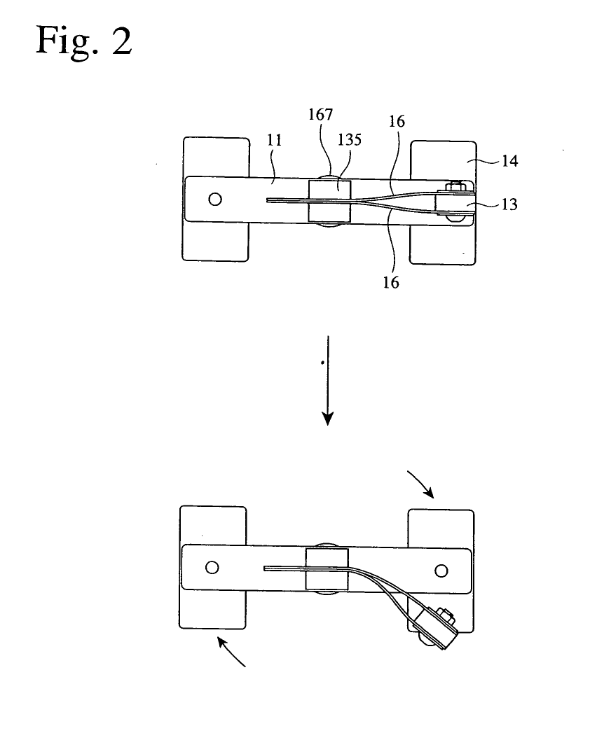

FIG. 2 is a plan view showing the movable permanent magnet member 13 of the viscosity-change-detecting apparatus 5, which moves when a reaction liquid in the stirring apparatus shown in FIG. 1 is rotated by the stirring rotor 1. As shown in FIG. 2, the viscosity-change-detecting apparatus 5 shown in FIG. 1 comprises two flat springs 16, 16. The flat springs 16, 16 are fitted in a slit of the fixed support 135 in an upper portion and fixed with a screw 167. When the stirring rotor 1 is rotated in a reaction liquid, a load is applied to the flat springs 16, 16 by the action of a rotating magnetic field, so that the flat springs 16, 16 are elastically bent substantially in a rotation direction of the reaction liquid while vibrating synchronously with a rotation period of the stirring rotor 1 as shown in FIG. 2. When the stirring rotor 1 rotates at a constant number of rotations, the flat springs 16, 16 are bent in proportion to the viscosity change of the reaction liquid, whereby the movable permanent magnet member 13 moves from the original position by a distance proportional to the degree of bending. Thus, as shown in FIG. 1, current or voltage is induced in an induction coil 6 attached to the outer wall of the container 2 substantially at the same height as the movable permanent magnet member 13, by the vibration of the movable permanent magnet member 13 in proportion to the change of the distance between the movable permanent magnet member 13 and the induction coil 6. As a result, the viscosity change of the reaction liquid can be detected by tracing the change of induced current or voltage. The viscosity may also be measured by the method mentioned later. In the present invention, the number of rotations of the stirring rotor and the viscosity-change-detecting stirring rotor mentioned below is preferably 100 to 600 rpm in the detection of viscosity and its change in the reaction liquid.

The material of the flat spring 16 is preferably a nonmagnetic metal. Among nonmagnetic metals, nonmagnetic stainless steel such as SUS304, etc. is preferable from the viewpoints of mechanical strength and chemical resistance. The measurement range of viscosity can be changed by changing the thickness, surface area or the number of the flat springs 16.

Other known elastics such as coil springs, fluororubbers, natural rubbers, organic synthetic rubbers, etc. may be used instead of the flat spring 16. The fluororubbers resistant to swelling by organic solvents are preferable as elastics.

Permanent magnets having strong magnetic force are preferably used as the movable permanent magnet member 13 to obtain high detection sensitivity. The permanent magnets having strong magnetic force are preferably rare earth magnets. Specific examples of preferable rare earth magnets include Nd—Fe—B magnets having Nd₂Fe₁₄B as a basic composition and Sm—Co magnets such as Sm(CoFeCuZr)₇, Sm(CoFeCu)₇, SmPrCo₅, SmCo₅. Among them, the Nd—Fe—B magnets are preferable. The movable permanent magnet member 13 is preferably coated with a chemically resistant resin such as fluororesin, etc., a ceramic, enamel or glass. Particularly, because the Nd—Fe—B magnets are poor in oxidation resistance and acid resistance, their surfaces are preferably coated completely with a resin with excellent oxidation resistance and acid resistance. Though the shape of the movable permanent magnet member 13 shown in FIGS. 1 and 2 is a rectangular parallelepiped, it may be properly changed depending on the requirements. The size of the movable permanent magnet member 13 may also be properly changed depending on the magnetic force required.

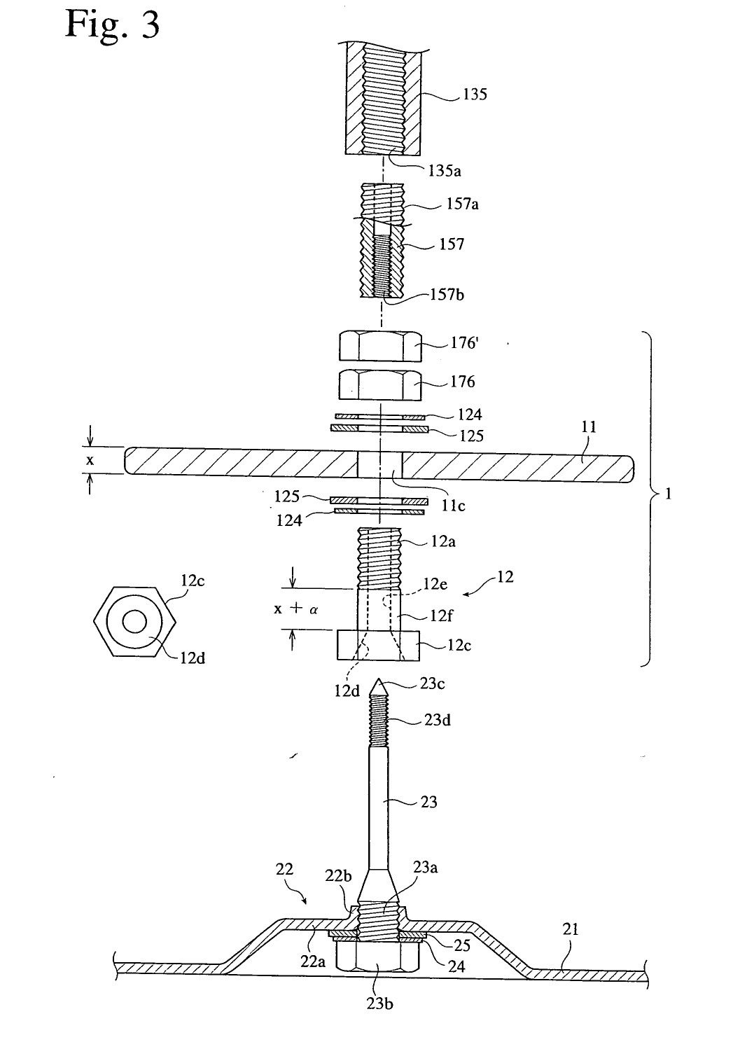

FIG. 3 shows the structure of the stirring rotor 1 assembled by attaching the tubular member 12, as a main part, and other members to the fixed shaft 23. The fixed shaft 23 is preferably threaded for easy fixing. The fixed shaft 23 comprises a male screw portion 23a, a hexagonal screw head 23b below the male screw portion 23a, a tapered tip end 23c and a male screw portion 23d near the tip end. The container bottom 21 has an upward dent 22 to fix the threaded, fixed shaft 23 to the flat bottom of the container 2. The upward dent 22 comprises a flat portion 22a and a projection 22b having a female screw.

The tubular member 12 comprises a male screw portion 12a, to which nuts 176, 176′ are fixed, and a hexagonal screw head 12c at the lower end. The screw head 12c has a tapered hole 12d connected to a through-hole 12e. The stirring rotor 1 comprises the horizontal member 11, the tubular member 12, and the nuts 176, 176′. The horizontal member 11 comprises a hole 11c at a rotation center, into which the tubular member 12 is inserted via a washer 124 and a packing 125. The nuts 176, 176′ are successively fixed to the male screw portion 12a from above via a washer 124 and a packing 125. The use of the nuts 176′, 176 prevents the nut 176 from being loosened. When the hole 11c of the horizontal member 11 has a smooth wall, the tubular member 12 preferably has a smooth portion 12f in contact with the hole 11c as shown in FIG. 3. In this case, when the hole 11c and the smooth portion 12′f have substantially the same diameter, the tubular member 12 is fully fixed to the hole 11c. The height of the smooth portion 12f may be (x+α), wherein x represents the thickness of the horizontal member 11, and α represents the sum of the thickness of the washers 124, 124 and the packings 125, 125. The hole 11c may have a threaded portion (not shown) fixed to the tubular member 12.

The fixed support 135 has a female screw portion 135a, to which the fixed shaft 23 is fixed. The female screw portion 135a of the fixed support 135 is fastened to the upper male screw portion 23d of the fixed shaft 23 via a hollow cylindrical joint screw 157 having a male screw portion 157a and a female screw portion 157b. With this structure, the fixed support 135 is non-rotatably fastened to the fixed shaft 23, while the stirring rotor 1 is rotatable around the fixed shaft 23. In order that the fixed support 135 permits the stirring rotor 1 to be rotatable around the fixed shaft 23, there should be a slight gap between the upper surface of the nut 176 of the stirring rotor 1 and the lower surface of the fixed support 135, requiring proper adjustment of length of each of the male screw portion 23d of the fixed shaft 23, the male and female screw portions 157a, 157b of the joint screw 157, and the female screw portion 135a of the fixed support 135. Though not shown in the figures, the fixed support 135 may be directly fastened to the fixed shaft 23 without using the joint screw 157.

With respect to other members than magnets and packings used in the stirring apparatus of the present invention, such as screws, support members, connecting members, etc., their materials are preferably nonmagnetic stainless steel such as SUS304, etc., unless otherwise particularly mentioned.

The horizontal member 11 having a stirring function keeps the balance of the stirring rotor 1 and supports the rotating permanent magnet members 14, 14. The horizontal member 11 preferably has a curved side surface at least at a rotation center, as exemplified by a horizontal member 11 in a stirring rotor 122 (shown in FIG. 20) mentioned below. Because stirring is weak at the rotation center, a solid substance precipitated in the reaction liquid tends to be attached to the side surface of the horizontal member 11 substantially at the rotation center. This is prevented by the curved side surface substantially at the rotation center. The curved side surface substantially at the rotation center provides improved stirring efficiency near the center of the bottom 21 of the container 2 (near a root of the fixed shaft 23). The shape of the curved side surface substantially at the rotation center is preferably part of a circle or an ellipse, which may bulge transversely as shown in FIG. 20. The horizontal member 11 does not necessarily extend horizontally from the rotation center in symmetry, but may extend from the rotation center in only one radial direction.

In the stirring apparatus capable of detecting viscosity change by induced current or voltage proportional to the distance between the movable permanent magnet member 13 and the induction coil 6 as shown in FIG. 1, the horizontal member 11 is preferably a yoke member. Using the yoke member as the horizontal member 11, the horizontal member 11 is subjected to a rotating magnetic field generated by a rotating magnet (a permanent magnet or an electromagnet) disposed below the bottom 21 of the container 2. Accordingly, the rotating permanent magnet members 14, 14 are not necessarily indispensable in the stirring rotor. When the rotor comprises rotating permanent magnet members 14, 14 with a sufficient magnetic force, the horizontal member 11 may be made of nonmagnetic materials.

Soft magnetic materials are preferably used for a yoke member constituting the horizontal member 11. Preferably used as soft magnetic materials are chemical-resistant metals such as soft magnetic stainless steel, etc. To improve chemical resistance, the horizontal member 11 is preferably coated with a chemically resistant resin such as fluororesin, etc., ceramic, enamel or glass.

When the horizontal member 11 is made of nonmagnetic materials, chemically and thermally resistant materials, or materials, on which chemical resistant layers are easily formed, are preferably used. Examples of such materials include nonmagnetic stainless steel, ceramics, high-strength plastics, etc.

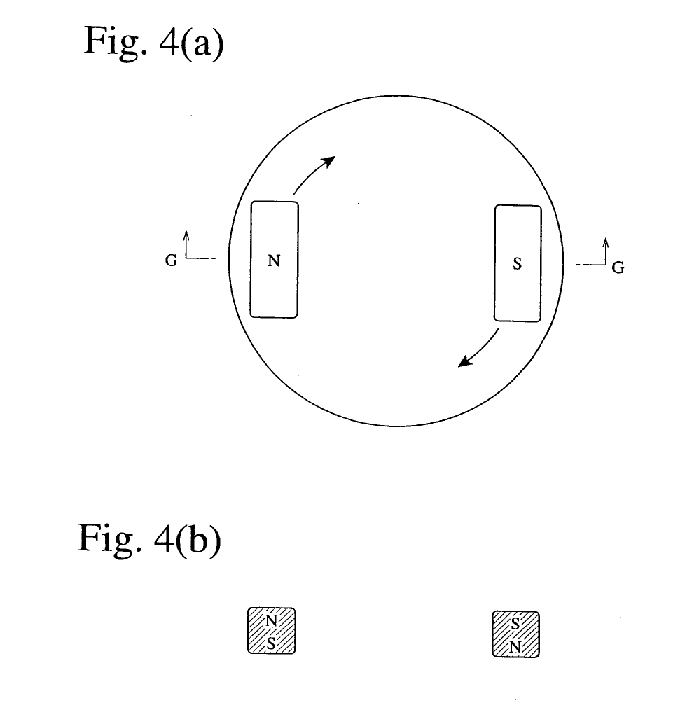

To provide the rotating permanent magnet members 14, 14 with high stirring power, a permanent magnet having high magnetic force is preferably used. The permanent magnets having a high magnetic force may be the same as those for the movable permanent magnet member 13. The rotating permanent magnet members 14, 14 are preferably coated in the same manner as in the movable permanent magnet member 13. The rotating permanent magnet members 14, 14 may be fixed not only by screws but also by adhesives, etc. Though the above stirring rotor 1 comprises a pair of rotating permanent magnet members 14, 14, at least one rotating permanent magnet member 14 generally provides the rotor with sufficient stirring power. In the rotor comprising a pair of rotating permanent magnet members 14, 14 as shown in FIG. 4, the permanent magnet members 14, 14 are preferably attached to the horizontal member 11 such that their magnetic poles are directed oppositely in a vertical direction.

Materials for the tubular member 12 are preferably metals such as stainless steels, etc., polyolefin resins such as polypropylene, high-density polyethylene, ultra-high-molecular-weight polyethylene, etc. fluororesins, ceramic, etc. from the viewpoints of mechanical strength, chemical resistance such as acid resistance and alkali resistance, and abrasion resistance. Coating is difficult in the through-hole 12e of the tubular member 12, and if possible, a coating inside the through-hole 12e of the tubular member 12 would be worn out by frequent contact with the fixed shaft during the rotation of the tubular member 12. Accordingly, when extremely good chemical resistance is required, the tubular member 12 per se is formed by materials with excellent chemical resistance. For instance, the entire tubular member 12 may be made of polyolefin such as ultra-high-molecular-weight polyethylene.

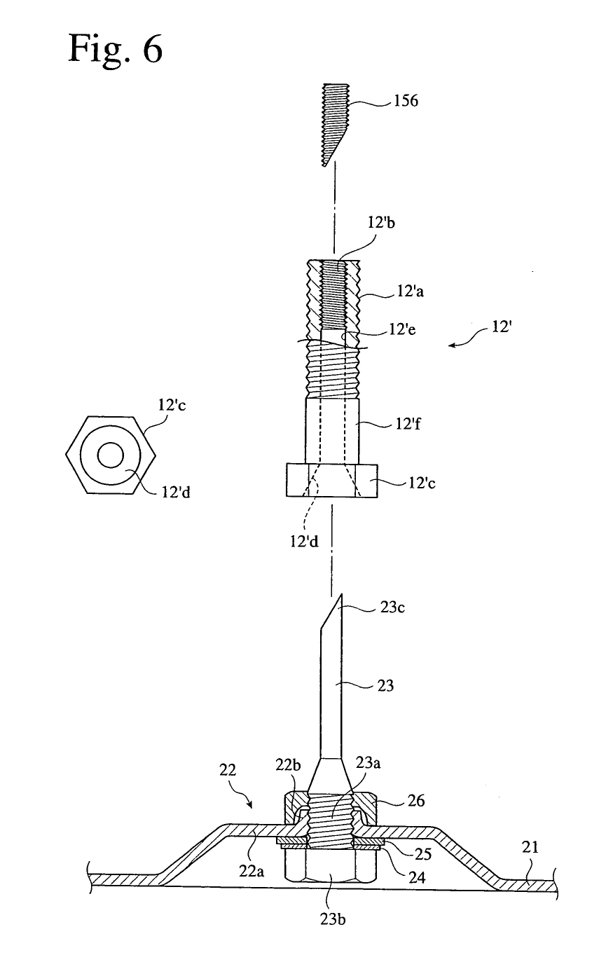

As shown in FIG. 3, the fixed shaft 23 is detachably fastened to the upward dent 22 of the container bottom 21 from below via the washer 24 and the packing 25. The fixed shaft 23 may be reinforced by a nut 26 having an inner surface covering the projection 22b as shown in FIG. 6. The male screw portion 23a has a sufficient length to be threaded into the projection 22b, so that the fixed shaft 23 is precisely vertical to the container bottom 21. Because the reaction liquid penetrates into a screwed portion, to make the fixed shaft 23 detachable is advantageous for cleaning. To prevent the reaction liquid from leaking outside during reaction, the packing 25 should be liquid-tight. The screwed portion may be sealed with adhesives, etc., if necessary.

Ceramics, stainless steel, etc. are preferably used for the fixed shaft 23 from the aspects of mechanical strength and chemical resistance such as acid resistance, alkali resistance, etc.

A material of the container 2 is selected depending on the composition of the reaction liquid used in reaction. When a usual organic solvent is used, the container 2 may be made of stainless steel. However, when excellent chemical resistance is required, the container 2 is lined with ceramic, enamel, glass or resins.

The viscosity measurement of the reaction liquid by the stirring apparatus shown in FIGS. 1 to 3 described above is conducted by the following procedure.
1. Selecting pluralities of standard solutions having different levels of viscosity covering the range of the viscosity change of the reaction liquid;
2. Stirring each standard solution under the same conditions (a stirring speed, a temperature, amount, an atmosphere) as in the reaction liquid, to cause an induction coil 6 to generate induced current or voltage, which is converted to a digital signal by an A/D converter and then input to a computer, thereby obtaining the relation between the induced current or voltage and the viscosity, using the correlation of the induced current or voltage with the viscosity of the standard solution;
3. Conducting a reaction to obtain induced current or voltage, which is input to the computer; and
4. Calculating the viscosity of the reaction liquid using the correlation of the induced current or voltage with the viscosity. This procedure is conducted to determine the viscosity of the reaction liquid from all data of the induced current or voltage obtained during the reaction.

A means for outputting induced current may comprise an AC current meter, and a means for outputting induced voltages may comprise an AC voltmeter. The relation between the induced current or voltage and the viscosity is re-calculated, when flat springs are replaced by those in different lots, when the number of flat springs used is changed, when flat springs are replaced by those having different thickness, or when the induction coil is changed.

The relation between the induced current or voltage and the viscosity is preferably obtained by using the standard solution under pluralities of conditions, for instance, at different stirring speeds, and stored as a database. With such database, the viscosity is quickly calculated from the stirring speed and the induced current or voltage obtained by measurement.

When the viscosity or its change of a reaction liquid having an extremely low the viscosity is measured, a baffle plate (not shown) is soaked in the reaction liquid to apply a load to the reaction liquid, thereby increasing the sensitivity of viscosity change. For the measurement of the viscosity, the relation between induced current or voltage and a viscosity is obtained beforehand from the standard solution with the baffle plate soaked in the same manner as above.

The material, diameter, shape, the number of turns, etc. of the induction coil 6 (see FIG. 1) may be properly selected depending on the required detection sensitivity. Though the induction coil 6 may be in a hollow shape, a core 61 improves its sensitivity as shown in FIG. 1. A solenoid is commercially available from CKD Corporation.

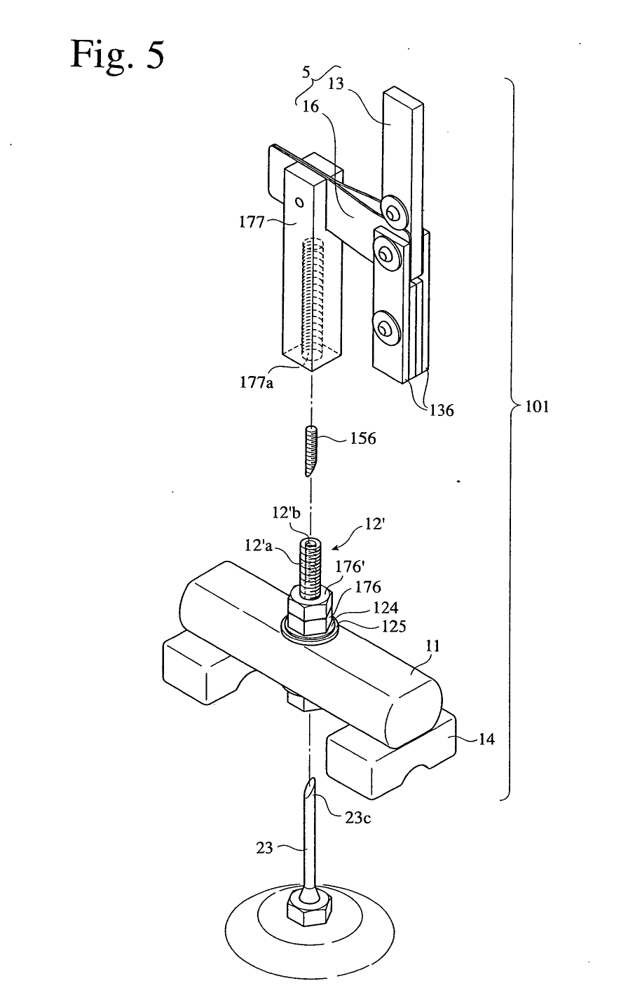

FIG. 5 is an exploded perspective view showing one example of a viscosity-change-detecting stirring rotor equipped with the viscosity-change-detecting apparatus of the present invention, which has a structure comprising a fixed vertical member 12′ as a main member. FIG. 6 shows a structure in which the fixed vertical member 12′ of the viscosity-change-detecting stirring rotor 101 shown in FIG. 5 is non-rotatably attached to the fixed shaft 23. The viscosity-change-detecting stirring rotor 101 comprises: (a) the fixed vertical member 12′ having a lower opening for receiving the fixed shaft 23 for supporting the viscosity-change-detecting stirring rotor 101, and non-rotatably attached to the fixed shaft 23; (b) a horizontal member 11 rotatably mounted to the fixed vertical member 12′ and extending from its rotation center, which causes stirring by rotation; (c) a column 177 fastened to an upper projection of the fixed vertical member 12′; (d) the viscosity-change-detecting apparatus 5 comprising flat springs 16, 16 detachably attached to the column 177 and radially extending therefrom, and a movable permanent magnet member 13 detachably mounted to the other ends of the flat springs 16, 16; and (e) a pair of rotating permanent magnets 14, 14 with magnetic poles oppositely directed in a vertical direction, which are fastened to the lower side edges of the horizontal member 11 so that the horizontal member 11 rotates by the action of a rotating magnetic field. Because the viscosity-change-detecting stirring rotor 101 comprises a blade 136 attached to a lower portion of the movable permanent magnet member 13, the flat springs 16, 16 are largely deformed by the viscosity change of the reaction liquid, improving the sensitivity of detecting the viscosity change.

The basic structure of the fixed vertical member 12′ comprising the viscosity-change-detecting stirring rotor 101 is the same as the tubular member 12 in the above stirring rotor 1, except that a long projection exists above the horizontal member 11, that a female screw portion 12′b exists inside the tip end portion, and that a stopping screw 156 having a slantingly cut tip end portion is fastened to the female screw portion 12′b. As shown in FIG. 6, the fixed shaft 23 having a slantingly cut tip end portion 23c is connected to the stopping screw 156 with a slantingly cut tip end portion, so that the fixed vertical member 12′ is non-rotatably fixed. In order that the horizontal member 11 smoothly rotates, as shown in FIG. 6, the fixed vertical member 12′ preferably has a flat portion 12′f, which is in contact with the inner wall of the hole 11c of the horizontal member 11. The hole 11c of the horizontal member 11 has a slightly larger diameter than that of the flat portion 12′f to secure the smooth rotation of the horizontal member 11 without wobbling. When the fixed vertical member 12′ is non-rotatably fixed like the viscosity-change-detecting stirring rotor 101, the opening 12′d of the head 12′c of the fixed vertical member 12′ may not be tapered but have the same diameter as that of the through-hole 12′e, for instance.

With the female screw portion 177a of the column 177 fastened to the male screw portion 12′a of the fixed vertical member 12′, the viscosity-change-detecting apparatus 5 is not rotatable.

To rotatably mount the horizontal member 11 to the fixed vertical member 12′, the position of the nut 176 is adjusted such that a slight gap remains between the upper surface of the horizontal member 11 and the lower surface of the nut 176 opposing each other via a washer 124 and a packing 125. In this case, the nut 176 is easily positioned by properly adjusting the length of the female screw portion 177a of the column 177 and the male screw portion 12′a of the fixed vertical member 12′, respectively. After positioning, the nut 176 is preferably fastened by screwing the nut 176′ from above as shown in FIG. 5.

Means for fastening the fixed vertical member 12′ to the fixed shaft 23 are not limited to those illustrated. For instance, the tip end portion 23c of the fixed shaft 23 may be in a shape of prism, half column, elliptic column, etc., and the hole 12′e of the fixed vertical member 12′ may have an upper portion engageable with the tip end portion 23c of the fixed shaft, or a stopping screw engageable with the tip end portion 23c of the fixed shaft may be fastened to the female screw portion 12′b of the fixed vertical member 12′, which are not shown. In addition, the male screw portion 23d may be formed in the tip end portion 23c of the fixed shaft like the embodiment shown in FIG. 3, and fastened to the female screw portion 12′b of the fixed vertical member 12′. Alternatively, the female screw portion 12′b of the fixed vertical member 12′ may be fastened to the male screw portion 23d via the joint screw 157 like the embodiment shown in FIG. 3.

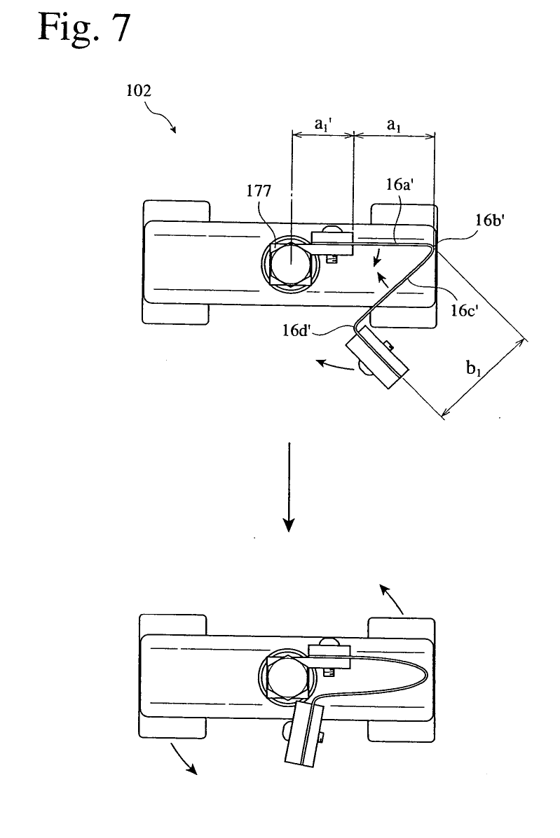

FIG. 7 is a plan view showing a viscosity-change-detecting stirring rotor according to a further embodiment of the present invention. The same reference numerals are assigned to the same members or parts as in the viscosity-change-detecting stirring rotor 101. The flat spring 16 of the viscosity-change-detecting stirring rotor 102 comprises a first deflectable portion 16a′ radially extending from the column 177, a first bent portion 16b′ at an outer end of the first deflectable portion, which is bent toward an opposite direction to a viscosity-resistance-receiving surface of the first deflectable portion 16a′, a second deflectable portion 16c′ connected to the first deflectable portion 16a′ in a substantially doglegged shape via the first bent portion 16b′, and a second bent portion 16d′ which is bent outward from the tip end of the second deflectable portion 16c′.

When a load is applied to the flat spring 16 by the counterclockwise rotation of the horizontal member 11 in the reaction liquid, the first deflectable portion 16a′ of the flat spring 16 is elastically deflected substantially in the rotation direction of the reaction liquid, and the second deflectable portion 16c′ is elastically deflected toward the first deflectable portion 16a′ together with the bending of the first bent portion 16b′, so that the movable permanent magnet member 13 becomes closer to the rotation center axis together with the bending of the second bent portion 16d′, as shown in FIG. 7. When the viscosity-change-detecting stirring rotor 102 is rotated at a constant number of rotations, the deflection degree of the flat spring 16 changes depending on the viscosity change of the reaction liquid, so that the movable permanent magnet member 13 moves from the original position toward the rotation center axis by a distance corresponding to the deflection degree. Thus, the viscosity change of the reaction liquid can be detected by tracing the change of the induced current or voltage depending on the change of the distance between the movable permanent magnet member 13 and the induction coil 6.

With the flat spring 16 provided with the first and second bent portions 16b′, 16d′ as in the viscosity-change-detecting stirring rotor 102, multistage deformation can occur in the flat spring 16, and the flat spring 16 can be made longer, resulting in improved detection sensitivity of viscosity change. The sum (a₁+a₁′) of the length a₁ of the first deflectable portion and the distance a₁′ from the center line of the horizontal member 11 in a transverse direction to the inner end of the first deflectable portion is preferably substantially the same as the distance from the rotation center to the end of the horizontal member 11, and the length a₁ is preferably ½ or more of (a₁+a₁′). To make the movable permanent magnet member 13 nearer the rotation center axis by the elastic deflection of the flat spring 16, the length b₁ of the second deflectable portion is preferably substantially the same as (a₁+a₁′).

Described above is the stirring apparatus comprising the viscosity-change-detecting stirring rotor 101 or 102 having the viscosity-change-detecting apparatus 5 attached via the column 177 to the fixed vertical member 12′ non-rotatably attached to the fixed shaft 23. In the stirring apparatus having the above structure, the viscosity-change-detecting apparatus 5 does not rotate with the horizontal member 11, thereby keeping space above the horizontal member 11 in portions except for those occupied by the fixed support 135, the column 177 and the viscosity-change-detecting apparatus 5. Accordingly, a means for detecting the state of a content is easily disposed in the container 2. Disposed therein may be, for instance, an electrode for measuring a hydrogen ion concentration, a pair of electrodes for measuring electric resistance, a tube for introducing an inert gas such as nitrogen, etc., and a tube for sucking part of the content.

Though the viscosity-change-detecting stirring rotor 102 comprises the fixed vertical member 12′ non-rotatably attached to the fixed shaft 23 as described above, what rotates is not limited to the horizontal member 11 in the viscosity-change-detecting stirring rotor, but the entire viscosity-change-detecting stirring rotor may rotate as a whole by the action of a rotation-force-providing means. Though such a viscosity-change-detecting stirring rotor has substantially the same appearance as the viscosity-change-detecting stirring rotor 101 shown in FIG. 5, it is rotatably supported as a whole by the fixed shaft 23, with the tubular member 12 comprising a stopper screw (I) 15a, by which the tubular member 12 abuts on the fixed shaft 23.

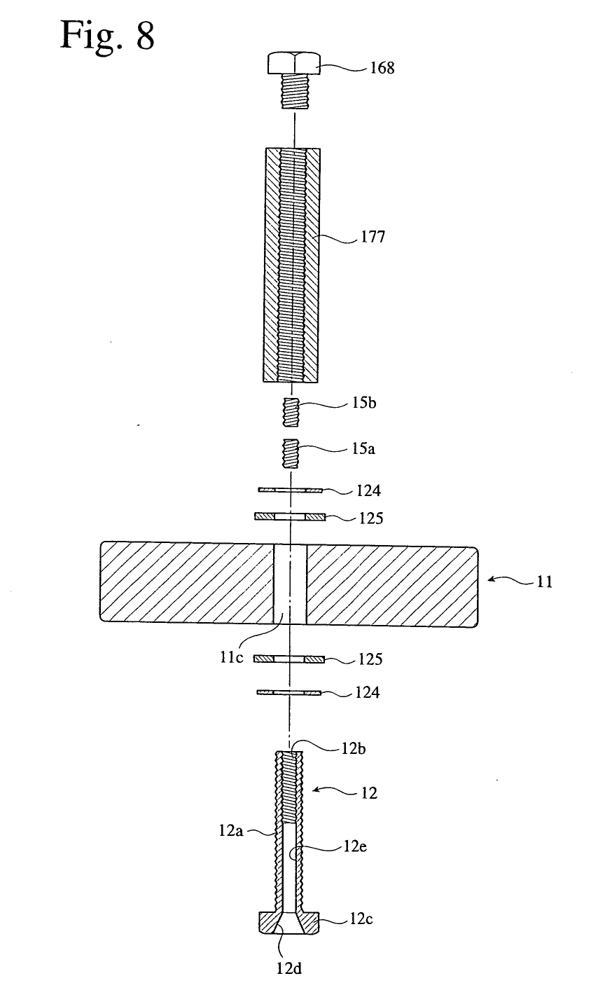

FIG. 8 shows the structure of a viscosity-change-detecting stirring rotor integrally rotated by the action of a rotation-force-providing means, whose members are assembled with a tubular member 12 as a main part. The tubular member 12 is inserted into a center hole 11c of the horizontal member 11 via a washer 124 and a packing 125, and a column 177 is detachably screwed to the tubular member 12 from above. 168 represents a bolt in FIG. 8.

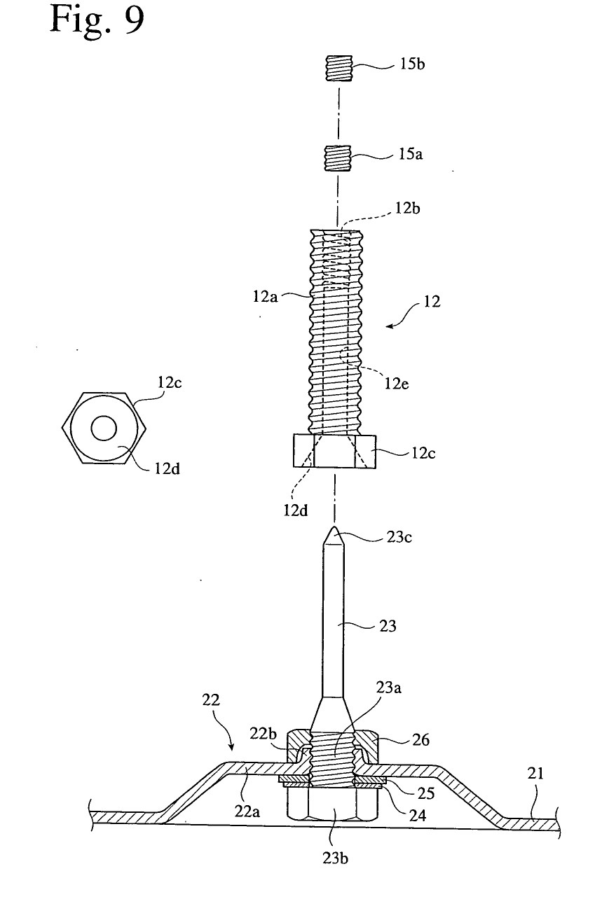

FIG. 9 shows the relation between the shaft 23 fixed to the container 2 and the tubular member 12. The fixed shaft 23 is the same as shown in FIG. 3, except that it does not have a male screw portion 23d at a tip end. The tubular member 12 has the same basic structure as in the above stirring rotor 1, except that it projects longer above the horizontal member 11, and that it has a female screw portion 12b inside the tip end portion, into which the stopper screw (I) 15a and the stopper screw (II) 15b are screwed. The depth of the fixed shaft 23 received in the through-hole 12e of the tubular member 12 is adjustable by the stopper screw (I) 15a. A stopper function is strengthened by screwing the stopper screw (I) 15a to the female screw portion 12b of the tubular member 12 and then screwing the stopper screw (II) 15b to fasten the stopper screw (I) 15a.

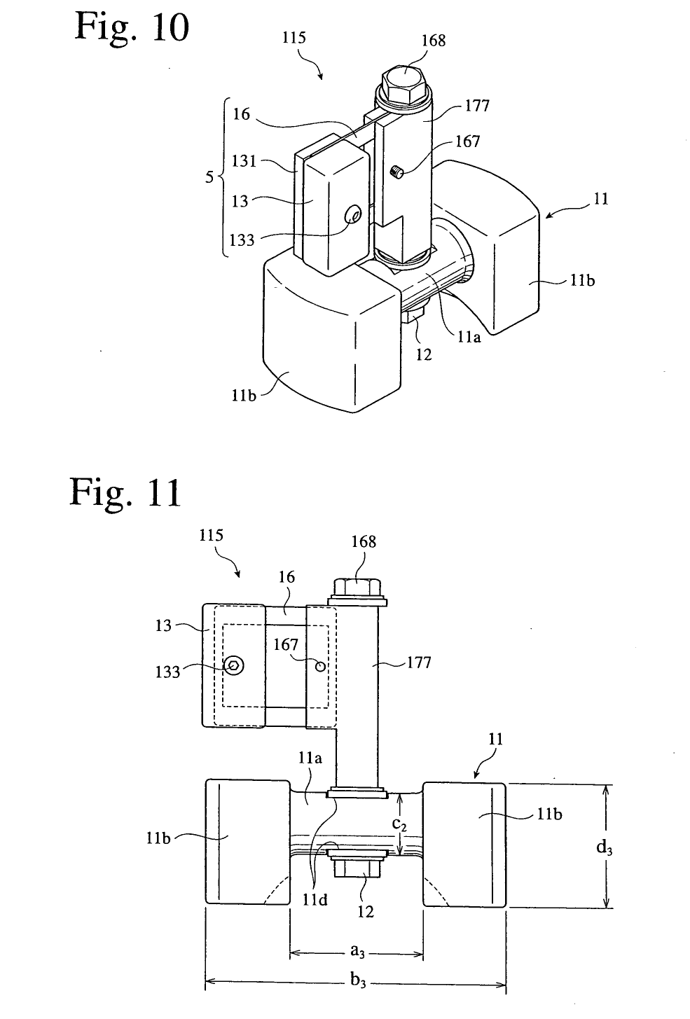

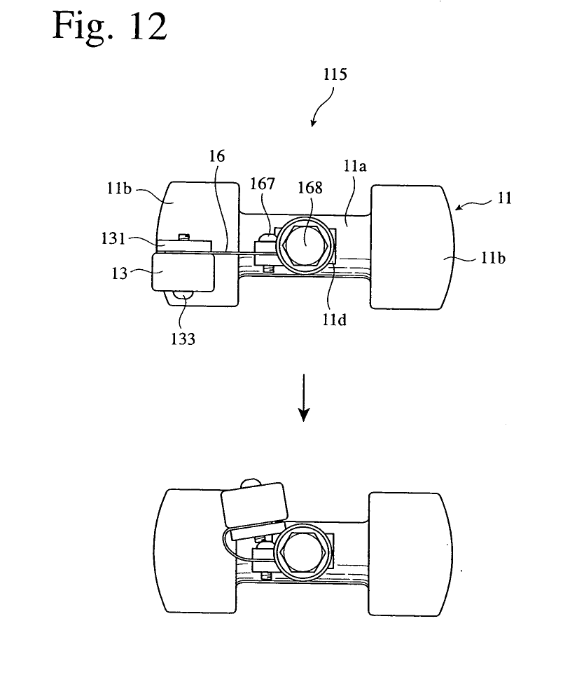

FIGS. 10 to 12 show examples of viscosity-change-detecting stirring rotors, which are integrally rotated by the action of a rotation-force-providing means. The same reference numerals are assigned to the same members or parts as in the viscosity-change-detecting stirring rotor 101. As shown in FIG. 12, when a viscosity-change-detecting stirring rotor 115 is rotated, a movable permanent magnet member 13 becomes nearer a rotation center axis as the viscosity resistance of a reaction liquid increases, so that its rotation radius becomes shorter. Thus, an induction coil 6 (see FIG. 1) disposed at a fixed position detects the change of a rotation radius, making it possible to detect the viscosity change of the reaction liquid.

The viscosity-change-detecting stirring rotor 115 is constituted by a yoke member as a horizontal member 11 with no rotating permanent magnet member 14, and the yoke member comprises a horizontal column 11a having a circular cross section. As described above, when a solid substance is precipitated in the reaction liquid, the horizontal circular-cross-sectional column 11a connecting blades 11b, 11b of the horizontal member 11 prevents the precipitated solid substance from attaching to the side surface of the horizontal member 11 substantially at the rotation center. Such a horizontal member provides higher stirring efficiency above and below the horizontal member 11a than the prism-shaped horizontal member 11a. When a reaction liquid is stirred by this horizontal member 11a in a container, a stirring efficiency is improved near the center of the bottom 21 of the container 2 (near the root of the fixed shaft 23). The horizontal circular-cross-sectional column 11a improves the yoke function of the horizontal member 11.

The length a₃ of the horizontal column 11a, the length b₃ of the horizontal member 11, the height c₂ of the horizontal member 11a and the height d₃ of the blade 11b may be properly decided depending on the size of the stirring apparatus, the viscosity of a content stirred, etc.

The horizontal column 11a is preferably provided with flat recesses 11d, 11d on upper and lower sides around the hole 11c, to secure that the tubular member 12 and the column 177 are attached to the horizontal member 111 without gap. Though the cross section of the horizontal member 11a is preferably circular, it may be elliptic, if necessary.

The viscosity-change-detecting stirring rotor 115 comprises a flat plate-shaped spring 16 as an elastic member. Because the flat plate-shaped spring 16 is subjected to large elastic deformation, as shown in FIG. 12, the rotation radius of the movable permanent magnet member 13 is easily changed depending on a load applied in a liquid during the rotation, resulting in improved detection sensitivity of the viscosity and its change.

When a rotating permanent magnet member 14 is attached to a lower portion (lower side end) of at least one of blades 11b of the viscosity-change-detecting stirring rotor 15, though not shown, the relative position of the movable permanent magnet member 13 to the rotating permanent magnet member 14 changes depending on the deflection of the coil spring 16 under a load applied in a liquid during the rotation. Thus, with an induction coil (I) positioned substantially at the same height as the movable permanent magnet member 13 and an induction coil (II) positioned substantially at the same height as the rotating permanent magnet member 14 in the outer wall of the container 2, the change of the relative position of the movable permanent magnet member 13 to the rotating permanent magnet member 14 causes a change in the difference between a phase A of current or voltage induced in the induction coil (I) by the rotation of the movable permanent magnet member 13 and a phase B of current or voltage induced in the induction coil (II) by the rotation of the rotating permanent magnet member 14, which difference is hereinafter called simply “phase difference AB.” In this case, the rotating permanent magnet member 14 is utilized as a reference permanent magnet for detecting the movement of the movable permanent magnet member 13. Accordingly, the viscosity change of the reaction liquid can be detected by tracing the phase difference AB at a constant number of rotations.

The viscosity-change-detecting stirring rotor capable of detecting the viscosity change of the reaction liquid by the phase difference AB preferably comprises a pair of rotating permanent magnet members 14, 14 at the ends of the horizontal member 11, with their magnetic poles oriented oppositely in a vertical direction as shown in FIG. 4. With such a structure, high detection sensitivity to the phase B can be achieved by the induction coil (II) positioned substantially at the same height as the horizontal member 11, because magnetic fluxes flowing from the upper N and S poles of the rotating permanent magnet members 14, 14 alternately cross the induction coil (II). To effectively use magnetic fluxes from the upper N and S poles of the rotating permanent magnet members 14, 14, the horizontal member 11 is preferably made of a non-magnetic material. When a magnetic member is used as the horizontal member 11 like the yoke member, magnetic fluxes flowing from the upper N and S poles of the rotating permanent magnet members 14, 14 are communicating through the yoke member, lowering the sensitivity of detecting the phase B.

The viscosity measurement of the reaction liquid by the rotor for detecting the viscosity change of the reaction liquid by the phase difference AB is conducted by the following procedure.
1. Selecting pluralities of standard solutions with different viscosities, whose range encompasses the viscosity change of the reaction liquid;
2. Stirring each standard solution under the same conditions (a stirring speed, a temperature, amount, an atmosphere) as in the reaction liquid, to cause an induction coil (I) to generate induced current or voltage having a phase A, and an induction coil (II) to generate induced current or voltage having a phase B by the rotation of the rotating permanent magnet members 14, 14, these induced currents or voltages being converted to digital signals by an A/D converter and then input to a computer to calculate the phase difference AB between the phases A and B (for instance, difference between the periodic signal peaks of the phases A and B), thereby obtaining the relation between the phase difference AB and the viscosity using the correlation of the phase difference AB with the viscosity of the standard solution;
3. Conducting a reaction to obtain phase difference AB, which is input to the computer; and
4. Calculating the viscosity of the reaction liquid using the correlation of the phase difference AB with the viscosity. This procedure is conducted to determine the viscosity of the reaction liquid from all data of the phase difference AB obtained during the reaction.

A means for outputting the phase of the induced current or voltage may be an oscilloscope, etc. The relation between the phase difference AB and the viscosity obtained by using the standard solution is preferably stored in a database with respect to pluralities of conditions such as a stirring speed (or the number of rotations). With such a database, the viscosity is quickly calculated by inputting the stirring speed (or the number of rotations) and the phase difference AB during the measurement.

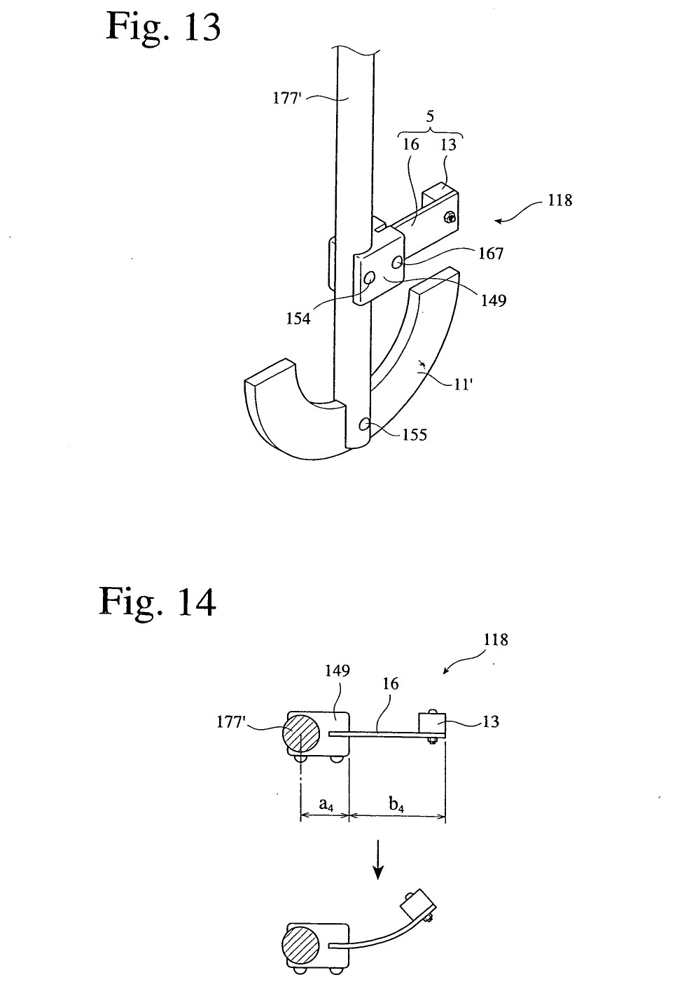

FIG. 13 shows a viscosity-change-detecting stirring rotor with a motor according to one embodiment of the present invention. The same reference numerals are assigned to the same members or parts as in the viscosity-change-detecting stirring rotor 101. The stirring rotor 118 comprises (i) a rotatable rod 177′; (ii) a semi-circular stirring member 11′ attached to the lower end of the rotatable rod 177′; (iii) a spring attachment 149 mounted to the rotatable rod 177′; (iv) the flat spring 16 attached to and radially extending from the spring attachment 149 above the stirring member 11′; and (v) the movable permanent magnet member 13 attached to the tip end portion of the flat spring 16.

When a load is applied to the flat spring 16 by the clockwise rotation of the stirring rotor 118 in the reaction liquid, the flat spring 16 is elastically deflected substantially in an opposing direction to the rotation direction of the rotor 118 as shown in FIG. 14, so that the movable permanent magnet member 13 becomes closer to the rotation center by the distance corresponding to its deflection, resulting in the change of the rotation radius of the movable permanent magnet member 13. According to the above procedure, the viscosity and its change of the reaction liquid can be measured by tracing the change of the current or voltage induced by the rotation of the movable permanent magnet member 13. A ratio a₄/b₄ of the length a₄ from the rotation center to the end of the spring attachment 149 to the length b₄ from the end of the spring attachment 149 to the end of the flat spring 16 is preferably ½. Though the stirring member 11′ and the spring attachment 149 are respectively fastened to the rotatable rod 177′ by screws 154 and 155, they may be welded thereto. Further, the shape of the stirring member 11′ and the position of the spring attachment 149 attached to the rotatable rod 177′ may be properly changed.

As described above with respect to the stirring rotor 115, if a reference permanent magnet is fixed to the rotatable rod 177′ or the stirring member 11′ at a different height from that of the movable permanent magnet member 13, though not shown, the viscosity and its change of the reaction liquid can be determined from the phase difference between the movable permanent magnet member 13 and the reference permanent magnet.

[2] Stirring Rotor and Stirring Apparatus Comprising it

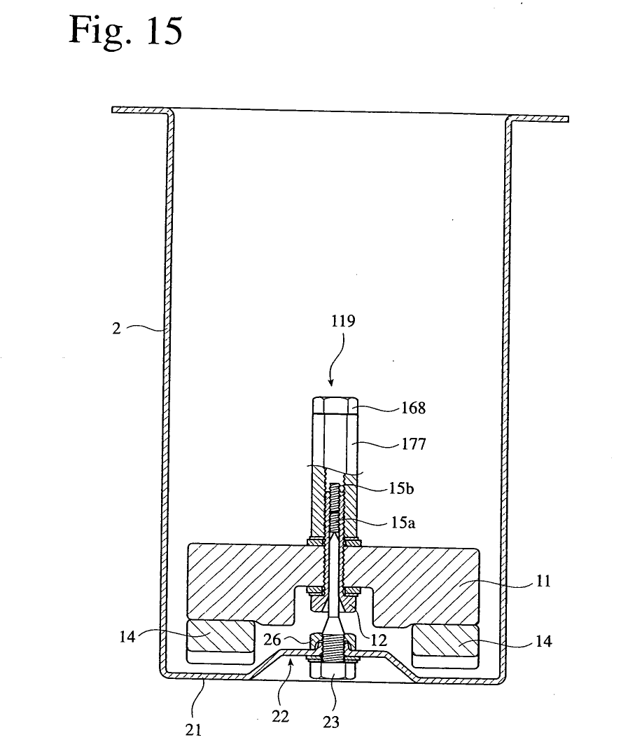

FIG. 15 shows one example of a stirring apparatus comprising the stirring rotor of the present invention in a container 2. The same reference numerals are assigned to the same members or parts as in the viscosity-change-detecting stirring rotor 101. Though this stirring rotor 119 does not have a viscosity-change-detecting apparatus, as shown in FIG. 15, its basic structure assembled with the tubular member 12 as a main part is the same as shown in FIGS. 8 and 9.

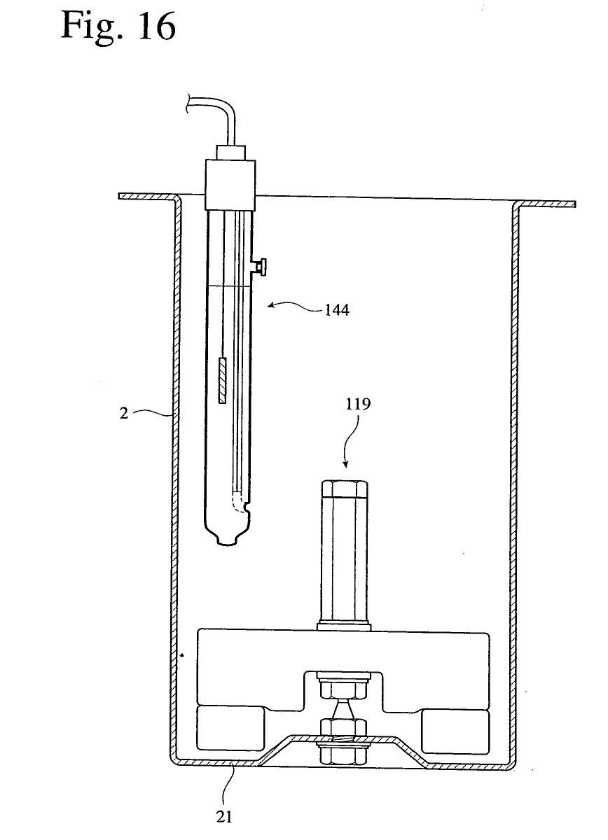

The horizontal member 11 of the stirring rotor 119 extends from a rotation center only in a substantially horizontal direction. Accordingly, the stirring apparatus having the stirring rotor 119 received in the container 2 has space in an upper portion except for a portion having the column 177 near the rotation center axis, as shown in FIG. 15. The arrangement of a means for detecting the state of a content in the container 2 is thus easy. For instance, FIG. 16 shows an example of a stirring apparatus comprising an electrode 144 for measuring the concentration of hydrogen ions in the container 2. In addition, a pair of electrodes for measuring electric resistance, a tube for introducing an inert gas such as nitrogen, etc., a tube for sucking part of the content, etc. may be arranged.

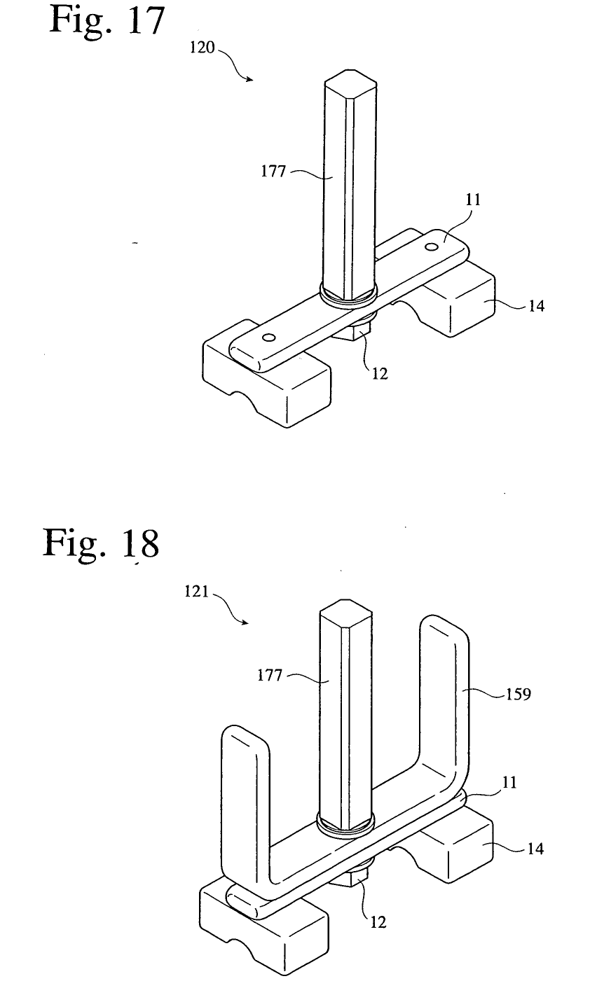

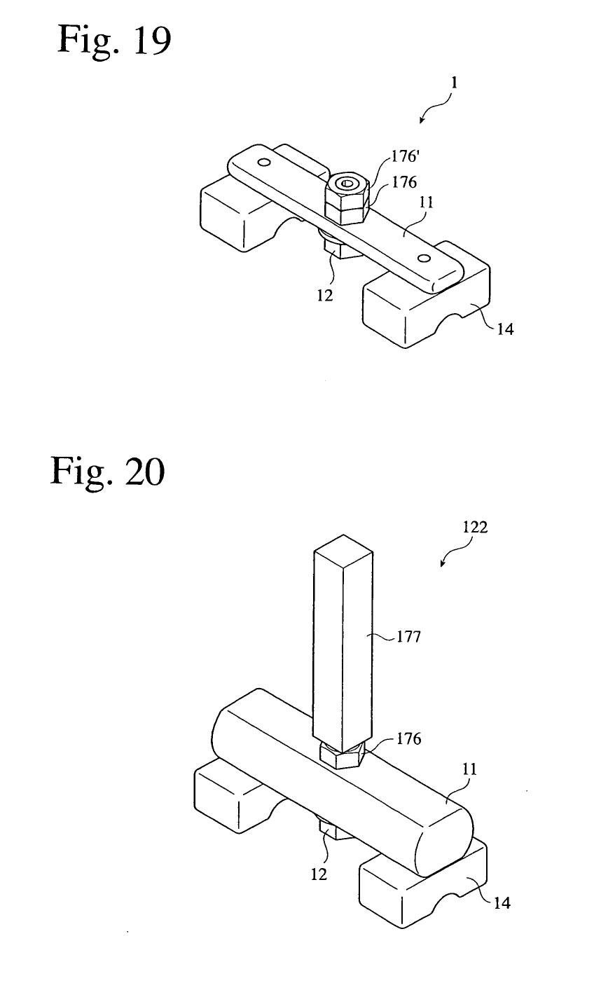

FIG. 17 shows another example of the stirring rotor of the present invention. The same reference numerals are assigned to the same members or parts as in the stirring rotor 119. As shown in FIG. 17, the stirring rotor 120 comprises a horizontal member 11 having a small vertical thickness, which is an advantageous structure when the reaction liquid is in a small amount. When the column 177 of the stirring rotor 120 is made of a fluororesin, the column 177 need not be coated with a resin, etc., and the rotor can be made light in weight. A stirring member 159 may be attached, if necessary, like the stirring rotor 121 shown in FIG. 18, and a short tubular member 12 may be used to omit the column 177, like the stirring rotor 1 shown in FIG. 19. Further, with the horizontal member 11 having a curved side surface at least near the rotation center like the stirring rotor 122 shown in FIG. 20, as described in [1] above, it is possible to prevent a solid substance precipitated in the reaction liquid from attaching to the side surface of the horizontal member 111 near the rotation center.

Using the same means as described in [1] above in relation to the viscosity-change-detecting stirring rotors 101 and 102 in the stirring rotor of the present invention, the tubular member 12 may be fastened to the fixed shaft 23 in place of the fixed vertical member 12′, so that only the horizontal member 11 is rotatable.

Though the present invention has been explained referring to the above specific examples, it is not restricted thereto, but any modifications may be added thereto unless deviating from the scope of the present invention.

### APPLICABILITY IN INDUSTRY

As described in detail above, in the viscosity-change-detecting apparatus of the present invention comprising (a) an elastically deflectable and/or twistable member, and (b) a movable permanent magnet member mounted to the elastic member directly or via a connecting member such that it moves depending on the deformation of the elastic member, fixing of part of the elastic member to the support mechanism makes the relative position of the movable permanent magnet member to a fixed external detector changeable depending on the viscosity change of the rotating liquid, so that the viscosity change of the liquid can be easily and accurately determined by detecting the change of the relative position by the external detecting means. Accordingly, the viscosity-change-detecting apparatus of the present invention is useful as a means for adding the function of detecting the viscosity change to a stirring rotor, a stirring apparatus, a reaction apparatus and a semi-automatic synthesis apparatus.

Because the horizontal member extending from a rotation center and generating a stirring function by rotation is fixed to the fixed shaft vertically extending along a rotation center axis and supporting the stirring rotor by the fixed vertical member non-rotatably attached to the fixed shaft in the first stirring rotor of the present invention, it occupies a drastically reduced space in the container, thereby making it easy to dispose an electrode, etc. in the stirring apparatus.

Because the second stirring rotor of the present invention comprises the tubular member at bottom, which rotatably receives the fixed shaft for supporting the rotor, and the horizontal member extending from a rotation center as a stirring member, it occupies a drastically reduced space in the container, thereby making it easy to dispose an electrode, etc. in the stirring apparatus.

1. A viscosity-change-detecting apparatus immersed in a rotating liquid for detecting its viscosity change, comprising
(a) an elastically deflectable and/or twistable member, and
(b) a movable permanent magnet member mounted directly or via a connecting member to said elastic member such that it moves depending on the deformation of said elastic member,
part of said elastic member being fixed to a support mechanism of said viscosity-change-detecting apparatus, so that said elastic member is subjected to elastic deflection and/or torsion with rotation and/or vibration in said rotating liquid, whereby the relative position of said movable permanent magnet member to a fixed external detector changes depending on the viscosity change of said liquid, and whereby the change of said relative position is detected by said external detector to detect the viscosity change of said liquid.

2. A stirring rotor rotating by the action of a rotating magnetic field, comprising
(a) a fixed vertical member extending along a rotation center axis and non-rotatably attached to a fixed shaft for supporting said rotor, and
(b) a horizontal member rotatably engaging said fixed vertical member and horizontally extending from a rotation center, which generates a stirring function by rotation.

3. A stirring rotor rotating by the action of a rotating magnetic field, comprising
(a) a horizontal member extending from a rotation center and having a stirring function, and
(b) a tubular member having at a lower end an opening for receiving a fixed shaft for supporting said rotor, which is attached to said horizontal member substantially at a rotation center from below.
